(19) United States
(12) Patent Application Publication
(10) Pub. No.: US 2003/0079500 A1
(43) Pub. Date: May 1, 2003

(54) Method for manufacturing information recording medium glass substrate

(76) Inventor: Tatsuro Umeyama, Osaka-shi (JP)

Correspondence Address: Y. ROCKY TSAO, Fish & Richardson P.C., 225 Franklin Street, Boston, MA, 02110-2804, US

(21) Appl. No.: 10/285,194

(22) Filed: Oct. 31, 2002

(30) Foreign Application Priority Data
Oct. 31, 2001 (JP) 2001-335193

(51) Int. Cl. C03C 17/00; C03C 17/28; C03C 15/00

(52) U.S. Cl. 65/30.1; 65/31; 65/30.14; 65/268

(57) ABSTRACT

A method for manufacturing an information recording medium glass substrate that prevents a glass plate from drying and prevents material from collecting on the surface when the glass plate is transferred. The method includes immersing the glass plate in a heated chemical strengthening liquid, washing the glass plate with warm water to remove adhered material from the surface of the glass plate, washing the glass plate to remove residual adhered material from the surface of the glass plate, and transferring the glass plate from a location at which the warm water washing is performed to a location at which the washing is performed by wetting or moistening the glass plate with liquid.

### BACKGROUND OF THE INVENTION

The present invention relates to a method for manufacturing an information recording medium, and more particularly, to a method for manufacturing a glass substrate, which is used by, for example, magnetic disks, magneto-optic discs, and optical discs.

In the prior art, an information recording medium substrate is manufactured by cutting out a disk-like glass plate from a glass sheet, polishing the surface of the glass plate, and washing the glass plate. A chemical strengthening process is performed to chemically strengthen the glass plate by immersing the plate into a solution of heated potassium nitrate, which serves as a chemical strengthening liquid. Then, warm water washing is performed to wash the glass plate with warm water and remove material, such as molten salt that collects on the surface of the glass plate in the chemical strengthening process. Afterward, a first washing process is performed with a scrubbing device, which is provided with a resin pad, to scrub the surface of the glass plate with the pad and remove adhered material still remaining on the plate surface subsequent to the warm washing process from the surface of the glass plate.

Subsequently, a second washing process is performed to first immerse the glass plate into an acid washing liquid and then into an alkali washing liquid in order to remove fine material adhered to the surface of the glass plate that was not removed by the scrubbing device. After the second washing process, the washing liquid is dried off from the surface of the glass plate. This completes the manufacturing of the information recording medium glass substrate. Further, a magnetic layer is formed on the surface of the information recording medium glass plate to manufacture, for example, a magnetic disc or a magneto-optical disc.

To increase the recording capacity of a glass substrate information recording medium, it is required that recording be performed with higher density and that the recording section be enlarged. Thus, the surface of the glass plate must be as smooth as possible. However, in the prior art information recording medium, during the period between the chemical strengthening process and the second washing process, there is a possibility that the glass plate may dry when transferred to perform a downstream process. If the glass plate dries up when transferred, material, such as molten salt, dust, and metal particles produced by each processing device, is fixed to the surface of the glass plate. The material fixed to the surface of the glass plate forms minute fine projections on the surface of the manufactured glass substrate. The minute projections lower the smoothness of the surface and may the glass substrate to be deficient. Thus, the yield of the glass substrates cannot be increased.

### SUMMARY OF THE INVENTION

It is an object of the present invention to provide a method for manufacturing an information recording medium glass substrate that prevents a glass plate from drying during transfer and prevents material from being fixed to the glass substrate.

To achieve the above object, the present invention provides a method for manufacturing an information recording medium glass substrate. The method includes polishing and cleaning the surface of a glass plate, chemically strengthening the glass plate by immersing the glass plate in a heated chemical strengthening liquid, washing the glass plate with warm water after the chemical strengthening step to remove material adhered to the surface of the glass plate therefrom, washing the glass plate after the warm water washing step to remove residual adhered material from the surface of the glass plate, and transferring the glass plate from a location at which the warm water washing step is performed to a location at which the washing step is performed by wetting or moistening the glass plate with liquid.

A further perspective of the present invention is a method for manufacturing an information recording medium glass substrate. The method includes polishing and cleaning the surface of a glass plate, chemically strengthening the glass plate by immersing the glass plate in a heated chemical strengthening liquid, washing the glass plate with warm water after the chemical strengthening step to remove material adhered to the surface of the glass plate therefrom, and washing the glass plate after the warm water washing step to remove residual adhered material from the surface of the glass plate. The washing includes a first washing step for scrubbing off the residual adhered material from the surface of the glass plate after the warm water washing step, and a second washing step for removing the residual adhered material from the surface of the glass plate after the first washing step with an acid washing liquid and an alkali washing liquid. The method further includes transferring the glass plate from a location at which the warm water washing is performed to a location at which the washing is performed by wetting or moistening the glass plate with liquid, and transferring the glass plate from a location at which the first washing step is performed to a location at which the second washing step is performed by wetting or moistening the glass plate with liquid.

A further perspective of the present invention is an apparatus for manufacturing an information recording medium glass substrate. The apparatus includes a chemical strengthening furnace for immersing the glass plate in a heated chemical strengthening liquid to perform chemical strengthening, a warm water washing device for washing the glass plate with warm water after the chemical strengthening to remove material adhered to the surface of the glass plate therefrom, a washing device for washing the glass plate after washing the glass plate with warm water to remove residual adhered material from the surface of the glass plate, and a transfer device for transferring the glass plate from the warm water washing device to the washing device by wetting or moistening the glass plate with liquid.

A further perspective of the present invention is a washing device used to manufacture an information recording medium glass substrate. The washing device includes a scrubber for scrubbing off adhered material from the surface of the glass plate after the glass plate is polished, a chemical washer for removing residual adhered material from the surface of the glass plate after the scrubbing with an acid washing liquid and an alkali washing liquid, and a conveyer arranged between the scrubber and the chemical washer to transfer the glass plate from the scrubber to the chemical washer. The conveyer includes a transfer tank for containing liquid, and a conveying belt arranged on the inner bottom surface of the transfer tank to transfer the glass plate in a state in which the glass plate is immersed in the liquid of the transfer tank.

A further perspective of the present invention is a transfer device used to manufacture an information recording medium glass substrate. The transfer device transfers a glass plate between a warm water washing device and a washing device. The transfer device includes a first conveyer for transferring the glass plate after the glass plate is washed with warm water, and an air purifier having a clean room for accommodating the glass plate transferred by the first conveyer. The air purifier purifies the clean room accommodating the glass plate so that the clean room shifts from a first atmosphere in which the amount of fine particles having a grain diameter of 0.5 μm or greater per cubic feet (0.028 cubic meter) is 10,000 or less to a second atmosphere in which the amount of fine particles having a grain diameter of 0.5 μm or greater per cubic feet (0.028 cubic meter) is 1,000 or less. The transfer device further includes a second conveyer for transferring the glass plate from the air purifier to the washing device. The air purifier includes a third conveyer for moving the glass plate from the first conveyer to the second conveyer in a state is which the glass plate is wet or moistened with liquid.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a flowchart illustrating a process for manufacturing a glass substrate according to a preferred embodiment of the present invention;

FIG. 2 is a schematic diagram illustrating chemical strengthening of a glass plate in the manufacturing process of FIG. 1;

FIG. 3 is a schematic diagram illustrating a warm water washing device for washing the glass plate with warm water in the manufacturing device of FIG. 1;

FIG. 4 is a schematic diagram illustrating a transferring device for transferring the glass plate in the manufacturing process of FIG. 1; and

FIG. 5 is a schematic diagram illustrating a washing device for washing the glass plate in the manufacturing process of FIG. 1.

### DETAILED DESCRIPTION OF THE PREFERRED EMBODIMENTS

In the drawings, like numerals are used for like elements throughout.

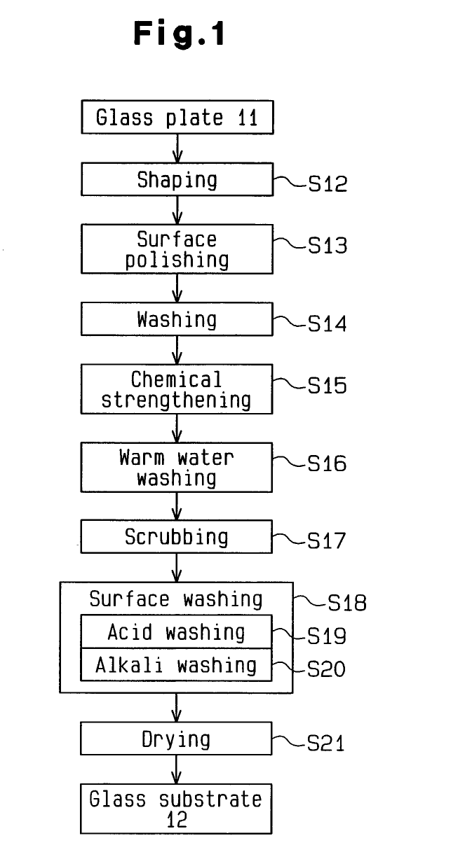

A process for manufacturing an information recording medium glass plate 22 according to a preferred embodiment of the present invention will now be discussed with reference to the flowchart of FIG. 1. The information recording medium glass substrate will hereafter simply be referred to as glass substrate.

First, in a shaping step S12, a disk-like glass plate 11 is cut out from a sheet of glass by a carbide or diamond cutter. A round hole extends through the center of the glass plate 11. In the shaping step S12, the glass plate 11 is polished so that it has the required inner and outer dimensions. Afterward, the corners at the outer and inner edges of the glass plate are ground and chamfered. The material of the glass plate 11 may be soda lime glass, alumino silicate glass, boro silicate glass, or crystallized glass, which are manufactured through a float process, a down draw process, a redraw process, or a press process.

Then, in a surface polishing step S13, the surface of the glass plate 11 is polished and smoothened. Afterward in the washing step S14, polishing grains, polishing material, and dust are removed from the surface of the glass plate 11. Then, in a chemical strengthening step S15, the glass plate 11 is chemically strengthened to improve the impact resistance characteristic, the vibration resistance characteristic, and heat durability of the glass plate 11.

More specifically, in the chemical strengthening step S15, the univalent metal ion included in the composition of the glass plate 11, such as lithium or natrium ion is replaced by a univalent metal ion having a larger diameter, such as potassium ion. Thus, a compression force acts on the surface of the glass plate 11 and strengthens the glass plate 11. After the chemical strengthening step S15, molten salt collects on the surface of the glass plate 11. The molten salt includes lithium ion and natrium ion, which are released into the chemical strengthening liquid.

In the warm water washing step S16, the molten salt on the glass plate 11 is mainly removed. In a scrubbing step (first washing step) S17, the glass plate 11 is scrubbed. In a surface washing step (second washing step) S18, the surface of the glass plate 11 is washed. The surface washing step S18 includes an acid washing step S19 and an alkali washing step S20. The glass plate 11 is washed in an acid washing liquid in the acid washing step S19 and then washed in an alkali washing liquid in the alkali washing step S20.

In a drying (finishing) step S21, the glass plate 11 is dried. This completes a glass plate 22. In the drying step S21, the liquid adhered to the glass plate 11, such as washing liquid, is removed. An underlayer, a magnetic layer, a protection layer, and a lubrication layer are sequentially formed on the surface of the glass plate 22 to manufacture, for example, a magnetic disc, a magneto-optic disc, or an optical disc.

The steps from the chemical strengthening step S15 to the drying step S21 will now be discussed in more detail. The chemical strengthening step S15 will first be discussed.

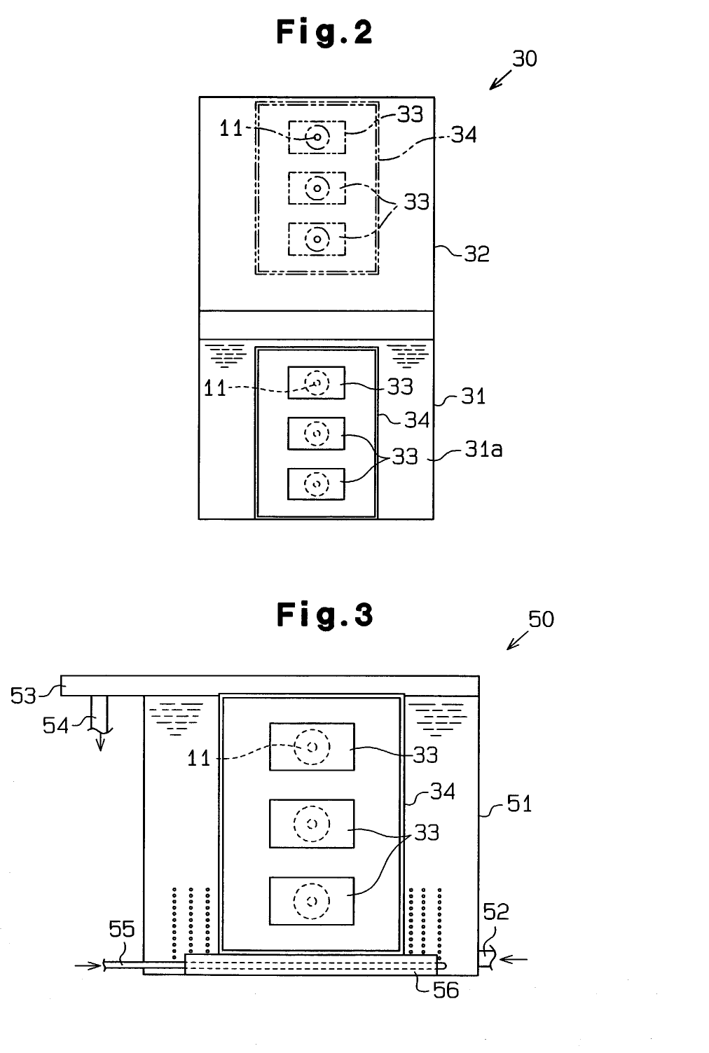

FIG. 2 is a schematic diagram illustrating chemical strengthening of the glass plate 11 in a chemical strengthening furnace 30. The chemical strengthening furnace 30 includes a chemical strengthening tank 31 and a cooling tank 32, which is arranged above the chemical strengthening tank 31. The interior of the chemical strengthening tank 31 and the interior of the cooling tank 32 are communicated with each other. The cooling tank 32 has a top plate, which is opened and closed.

The chemical strengthening tank 31 contains a chemical strengthening liquid 31a. The chemical strengthening liquid 31a is one of or a mixture of at least two of, for example, a potassium nitrate solution, a sodium nitrate solution, and silver nitrate.

The chemical strengthening liquid 31a is heated by a heater (not shown), which is located near the chemical strengthening tank 31. It is preferred that the temperature of the chemical strengthening liquid 31a be lower than the deforming point of the glass plate 11 by about 50° C. to 150° C. It is further preferred that the temperature of the chemical strengthening liquid 31a be lower than the deforming point of the glass plate 11 by about 350° C. to 400° C. The interior temperature of the cooling tank 32 is lower than the ambient temperature due to the heat produced by the chemical strengthening tank 31.

A plurality of the glass plates 11 are retained in holders 22. The holders 33 are accommodated in a cage 34. The same holders 33 and cage 34 are used and the glass plates 11 are not replaced between the periods from the chemical strengthening step S15 to the scrubbing step S17. The glass plates 11 are placed in the chemical strengthening tank 31 from the top of the tank 31 and immersed in a chemical strengthening liquid 31a together with the holders 33 and the cage 34. Since the holders 33 and the cage 34 are immersed in the chemical strengthening liquid 31a, it is preferred that the holders 33 and the cage 34 be made of a heat resistant and corrosion resistant metal, such as stainless steel, nickel alloy (e.g., Inconel), titanium, or titanium alloy.

When performing chemical strengthening on the glass plates 11 in the chemical strengthening furnace 30, the glass plates 11 are retained in the holders 33, and the holders 33 are accommodated in the cage 34. Afterward, the cage 34 holding the holders 33 is transferred to the chemical strengthening furnace 30 and placed in the chemical strengthening tank 31 by way of the cooling tank 32. Then, the glass plates 11, together with the holder 33 and the cage 34, are immersed in the chemical strengthening liquid 31a, which is 350° C. to 400° C. for a predetermined time and chemically strengthened.

As shown by the dotted lines in FIG. 2, the chemically strengthened glass plates 11 are lifted to the cooling tank 32 together with the holders 33 and the cage 34 and then slowly cooled. In this state, the molten salt in the chemical strengthening liquid 31a, dust, and the particles of the metals forming the chemical strengthening furnace 30, the holders 33, and the cage 34 are collected on the surface of the glass plates 11. The slowly cooled glass plates 11 are then transferred to a warm water washing device 50 together with the holders 33 in a state in which the glass plates 11 are accommodated in the cage 34 to perform the warm water washing step S16.

The warm water washing step S16 will now be discussed.

FIG. 3 is a schematic diagram of the warm water washing device 50, which washes the glass plates 11 with warm water. The warm water washing device 50 includes a warm water washing tank 51. The washing tank 51 is box-like and has an opened top. A seat 56 is arranged on the inner bottom surface of the washing tank 50 to receive the cage 34. A supply pipe 52 is connected to a lower portion of one side of the washing tank 51. Warm water, the temperature of which is 30° C. to 70° C., is supplied to the interior of the washing tank 51 through the supply pipe 52. An overflow portion 53 extends laterally from an upper portion of one side of the washing tank 51. A drain pipe 54 is connected to the lower surface of the overflow portion 53. The warm water in the washing tank 51 drains out of the overflow portion 53 by way of the drain pipe 54.

An air supply pipe 55 is arranged on the inner bottom surface of the washing tank 51 and extends out of the washing tank 51. A plurality of holes are formed in the wall of the air supply pipe 55. The air supply pipe 55 is connected to a pump (not shown), which is located outside the washing tank 51. Bubbles of air are released into the washing tank 51 through the holes of the air supply pipe 55. The bubbles contact the glass plates 11, which are accommodated in the cage 34 and remove material adhered to the surface of the glass plates 11.

It is preferred that filtered pure water, ion exchange water, or ultrapure water be used as the warm water. As long as the surfaces of the glass plates 11 are not affected, alcohol (e.g., isopropyl alcohol (IPA), methanol, ethanol, or butanol) or cation, anion, or nonion surface active agent may be mixed with water.

The cage 34, which is transferred from the chemical strengthening furnace 30 to the warm water washing device 51, is placed on the seat 56 in the washing tank 51. In this state, the glass plates 11 are immersed in the warm water in the washing tank 51. Then, when air is supplied to the air supply pipe 55, bubbles are released into the washing tank 51 and the bubbles contact the surfaces of the glass plates 11.

As a result, the bubbles free molten salt from the surfaces of the glass plates 11 and cause the molten salt to be dissolved in the warm water. The metal particles and dust included in the molten salt are also freed from the surfaces of the glass plates 11 with the molten salt and dispersed in the warm water by the bubbles. The warm water in which material is dissolved or dispersed is drained out from the overflow portion 53. The glass plates 11 are washed with warm water for a predetermined time. Then, the glass plates 11 are transferred to perform the following first washing (scrubbing) step in a state in which the glass plates 11 are retained in the cage 34.

The first washing step will now be discussed.

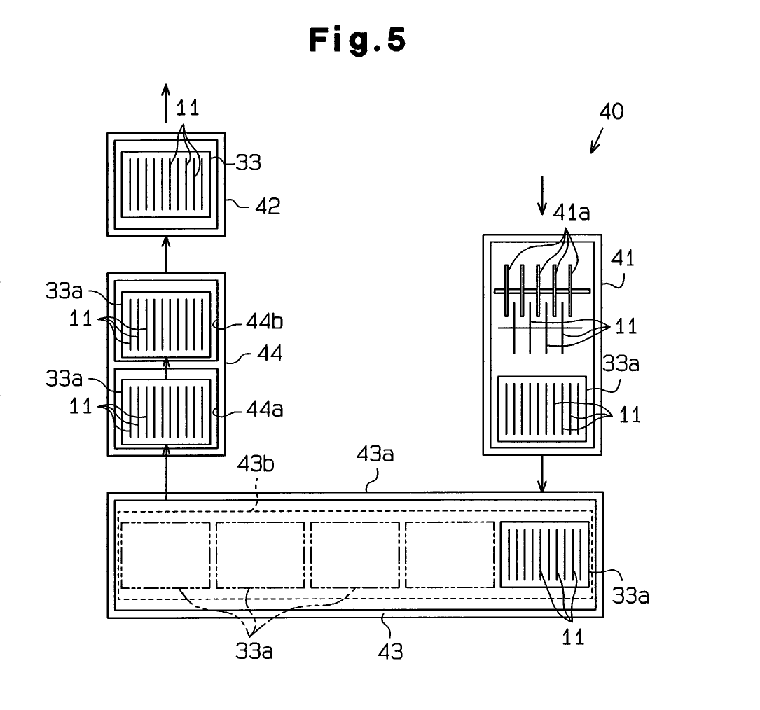

FIG. 5 is a schematic diagram of a washing device 40, which successively performs the scrubbing step S17 to the drying step S21. The washing device 40 has a scrubber 41 and a drier 42. A conveyer 43 and a chemical washer 44 are arranged between the scrubber 41 and the drier 42 in the washing device 40. The scrubber 441, the conveyer 43, the chemical washer 44, and the drier 42 are arranged in the washing device 40 in a U-shaped manner when seen from above to save space.

The scrubber 41 is provided with a plurality of washing pads 41a, which is softer than the glass plates 11. In addition to organic material (e.g., suede or sponge made of polyvinyl alcohol), non-organic material, metal material, or a composite of these materials may be used as the material of the washing pads 41a. The material of the washing pads 41a may be either hard or soft.

The glass plates 11 washed with warm water are transferred to the washing device 40 and removed from the cage 34 together with the holders 33. Then, the glass plates 11 are removed from the holders 33 and placed in the scrubber 41. The glass plates 11 are held vertically and spaced apart from one another. The washing pads 41a are inserted between the glass plates 11 while spraying water on each glass plate 11. The washing pads 41a scrub the surfaces of the glass plates 11. This scrubs off the material adhered to the surfaces of the glass plates 11.

The conveyer 43 transfers the glass plates 11 in a state immersed in water from the scrubber 41 to the chemical washer 44. The conveyer 43 includes a transfer tank 43a. The transfer tank 43a is an elongated box and has an opened top surface. Water is contained in the transfer tank 43a. A conveying belt 43b is arranged on the bottom of the transfer tank 43a.

The scrubbed glass plates 11 are retained in holders 33a of the scrubber 41. Then, together with the holders 33a, the glass plates 11 are arranged on the conveying belt 43b and submerged in water in the transfer tank 43a. Portions of the holders 33a that contact the glass plates 11 are formed of a synthetic resin (e.g., fluororesin) that resists heat and chemicals. Other portions are formed of a metal that resists heat and acid. Thus, particles of the metal forming the holders 33a and rust are prevented from collecting of the glass plates 11 that are retained in the holders 33 of the washing device 40. In a state in which the glass plates 11 are immersed in water and prevented from being dried, the glass plates move in the transfer tank 43a as shown by the dotted lines in FIG. 5 to be transferred to the chemical washing device 44.

In the surface washing step S18, the chemical washing device 44 uses acid and alkali washing liquids to remove material that was not scrubbed off, such as metal particles biting into the surfaces of the glass plates 11. The chemical washing device 44 has an acid washer 44a and an alkali washer 44b, which are partitioned from each other. The acid washer 44a contains acid a washing liquid, such as hydrofluoric acid, sulfuric acid, sulfamic acid, hydrochloric acid, or phosphoric acid. The alkali washer 44b contains an alkali liquid, such as potassium hydroxide, sodium hydroxide, ammonia, or tetramethyl hydroxides.

The glass plates 11, which are transferred in a state immersed in water in the conveyer 43, are placed in the acid washer 44a and immersed in the acid washing liquid in a state retained in the holders 33a. In a state in which the glass plates 11 are immersed in the acid washing liquid, ultrasonic waves are emitted to the glass plates 11. Afterward, the glass plates 11 are transferred from the acid washer 44a to the alkali washer 44b in a state retained in the holders 33a. In a state in which the glass plates 11 are immersed in an alkali washing liquid, ultrasonic waves are emitted to the glass plates 11.

The reasons for first washing the glass plates 11 with the acid washing liquid and then washing the glass plates 11 with the alkali washing liquid will now be discussed. In an acid solution, the glass plates 11 are electrified to negative polarity, and the material, such as a polishing agent, that collects on the surfaces of the glass plates 11 tend to be electrified to positive polarity. Thus, when washing the glass plates 11 only with the acid washing liquid, static electricity may cause the material dispersed in the solution to collect again on the surface of the glass plates 11. On the other hand, in the alkali solution, the glass plates 11 are electrified to negative polarity, and the material, such as a polishing agent, that collects on the surfaces of the glass plates 11 also tend to be electrified to negative polarity. Thus, the glass plates 11 and the collecting material are repelled from each other, and the material adhered to the surfaces of the glass plates 11 are prevented from adhering to the surfaces again.

The drier 42 removes water, the acid washing liquid, the alkali washing liquid, and salt, which is deposited on the surfaces of the glass plates 11 when immersing the glass plates 11 in the alkali washing liquid after immersing the glass plates 11 in the acid washing liquid, from the surfaces of the glass plates 11 and dries the glass plates 11. The drier 42 includes a sprayer (not shown) for spraying the vapor of an organic solvent, which has a low boiling point. It is preferred that a hydrophilic substance enabling the acid and alkali washing liquid to be dissolved in water be employed as the low boiling point organic solvent employ. Isopropyl alcohol (IPA) is mainly used as the solvent.

The glass plates 11 are transferred from the chemical washer 44 to the drier 42 in a state in which the glass plates 11 are accommodated in the holders 33a. The sprayer sprays IPA vapor toward the glass plates 11 in the drier 42. Water, which is a liquid, and the alkali washing liquid is mainly dissolved in the IPA vapor and immediately vaporizes with the IPA vapor. This dries the surfaces of the glass plates 11. Thus, the glass plates 11 are dried without leaving any traces of water flowing on the surfaces of the glass plates or depositing salt on the glass plates 11. In the chemical washer 44, the surface washing step S18, which includes the acid washing step S19 and the alkali washing step S20, are performed by the drier 42. The drier 42 performs the drying step S21. The glass plates 22 are removed from the upstream end of the washing device 40. In this state, the glass plates 22 are finished products.

The transfer of the glass plates 11 to perform the warm water washing step S16 and the first washing (scrubbing) step S17 will now be discussed.

It is preferred that each operation including the transfer of the glass plates 11 to perform the chemical strengthening step S15 and the warm water washing step S16 be performed in an atmosphere (cleanness) in which the amount of dust (fine particles) having a grain diameter of 0.5 μm or greater is 10,000 or less per one cubic feet (0.028 cubic meter). If the amount of fine particles is 10,000 or greater, there is a possibility of a large amount of fine particles collecting on the glass plates 11 in a manner such that the glass plates 11 cannot be visually confirmed during transfer.

It is preferred that the transfer of the glass plates 11 to execute the steps subsequent to the first washing step S17 be performed in an atmosphere (cleanness) in which the amount of fine particles having a grain diameter of 0.5 μm or greater is 5,000 or less per one cubic feet. If the amount of fine particles is 1,000 or greater, there is a possibility of fine particles collecting on the glass plates 11 during the washing. This would produce small scratches on the glass plates 11. In such a case, deficient glass plates 22 would be manufactured.

With regard to cleanness in each step, although not regulated, the maximum grain diameter of the fine particles is normally 100 μm or less. Fine particles that are larger than 100 μm may be visually confirmed and float when immersed in water. Thus, these particles are easily removed.

The cleanness level of the steps up to the warm water washing step S16 differs from that of the steps from the first washing step S17. Thus, the transfer of the glass plates 11 between the warm water washing step S17 and the first washing step S17 is performed using a predetermined transfer device 60.

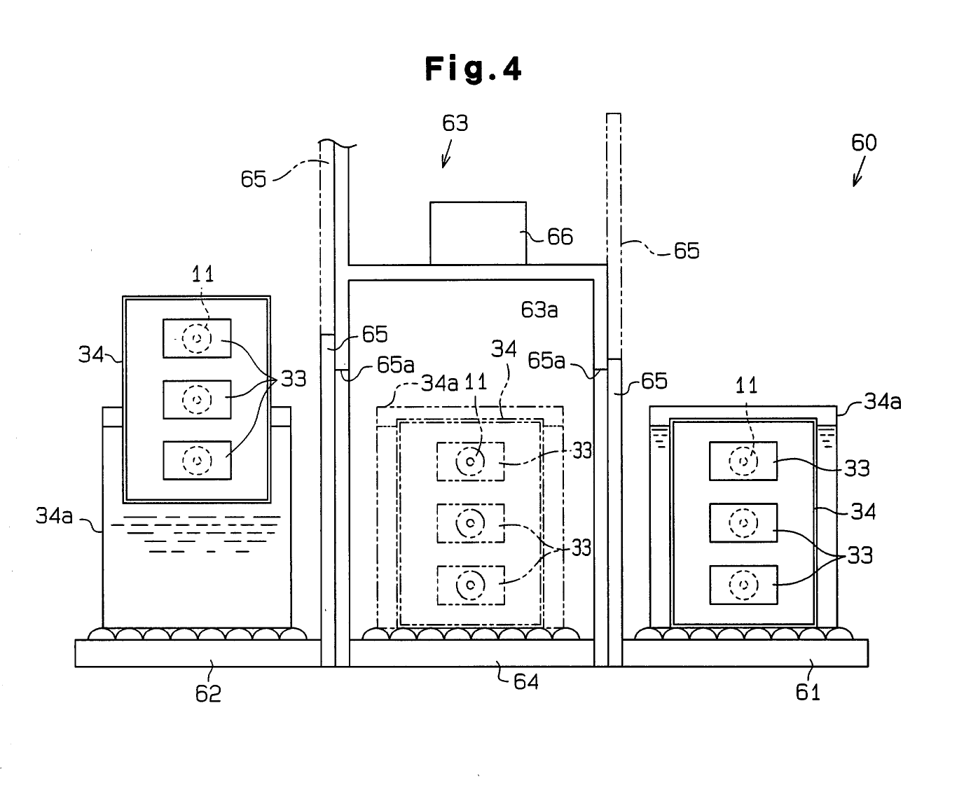

FIG. 4 is a schematic diagram of the transfer device 60. The transfer device 60 includes a first conveyer 61 and a second conveyer 62, which transfer the glass plates 11 subsequent to the completion of the warm water washing step S16 in a state in which the glass plates 11 are accommodated in the cage 34.

The first conveyer 61 extends from the vicinity of the warm water washing device to an air purifier 63 and is arranged in an atmosphere in which the amount of fine particles having a grain diameter of 0.5 μm or greater is 10,000 or less per cubic feet. The second conveyer 62 extends from the air purifier 63 to the vicinity of the washing device 40 and is arranged in an atmosphere in which the amount of suspended material having a grain diameter of 0.5 μm or greater is 1,000 or less per cubic feet.

The air purifier 63 has a clean room 63a, which is surrounded by walls. A third conveyer 64, which transfers the cage 34 from the first conveyer 61 to the second conveyer 62 is arranged on the inner bottom portion of the clean room 63a. Among the walls defining the clean room 63a, openings 65a are formed in the walls facing the first conveyer 61 and the second conveyer 62. When the openings 65a are closed by doors 65, which open and close automatically, the clean room 63a is sealed. An air purifying device 66 is attached to the top wall of the clean room 63a to improve the cleanness of the clean room 63a.

During the period between the warm water washing step S16 and the first washing step S17, the glass plates 11 transferred by the transfer device 60 are accommodated in the cage 34 in a state retained in the holders 33. The cage 34 is placed in a container 34a containing liquid, such as water, and sealed by the liquid. Then, in a state retained in the holders 33, the glass plates 11 are immersed in the water of the container 34a. This reduces the attraction of material relative to the surface of the glass plates 11 and frees most of the material from the surface of the glass plates 11. Further, the glass plates 11 are not dried and transferred in a wet state. This prevents material from collecting and adhering to the glass plates 11.

It is preferred that filtered pure water, ion exchange water, or ultrapure water be used as the water in the container 34a. As long as the surfaces of the glass plates 11 are not affected, alcohol (e.g., isopropyl alcohol (IPA), methanol, ethanol, or butanol), or cation, anion, or nonion surface active agent may be mixed with water.

It is preferred that the water temperature at locations in which each step and transfer is performed be about the same as the ambient temperature, more specifically, 5° C. to 30° C. If the temperature is 5° C. or less, there is a possibility of water freezing and the attraction of the polishing material not being decreased in the desired manner. If the water temperature is greater than 30° C., the glass plates 11 tend to dry and bacteria is easily produced in the water. Therefore, in addition to the polishing material, bacteria may collect on the surfaces of the glass plates.

In a state accommodated in the cage 34, the glass plates 11 transferred from the warm water washing device 50 are placed in the container 34a, which is held on the first conveyer 61, and immersed in water. The first conveyer 61 then conveys the glass plates 11 in a state immersed in the water of the container 34a to a location just before the air purifier 63.

When the glass plates 11 are transferred to a position just before the air purifier 63, the door 65 located on the side of the first conveyer 61 is automatically opened while the door 65 at the side of the second conveyer 62 remains closed. Subsequently, as shown by the dotted lines in FIG. 4, the container 34a accommodating the glass plates 11 is transferred from the first conveyer 61 to the third conveyer 64 and placed in the clean room 63a. Then, the door 65 at the side of the first conveyor 61 is closed to seal the clean room 63a. The air purifying device 66 is operated in this state to purify the clean room 63a until the amount of fine particles having a grain diameter of 0.5 μm or greater per cubic meter becomes 1,000 or less.

The door 65 at the side of the second conveyer opens when the clean room 63a is purified. Then, the container 34a accommodating the glass plates 11 is transferred from the third conveyer 64 to the second conveyer 62 and moved out of the clean room 63a. The cage 34 accommodating the glass plates 11 is lifted from the container 34a and transferred to a position near the purifying device 40.

The above method for manufacturing the glass substrates has the advantages described below.

(1) During the steps between the chemical strengthening step S15 and the drying step S21, the glass plates 11 are transferred in a state immersed in water. Water decreases the attraction of material relative to the surfaces of the glass plates 11. Further, by immersing the glass plates 11 in water, the glass plates 11 are prevented from drying when transferred to perform each step. Further, the collection of material on the glass plates 11 is suppressed and yield is increased.

(2) After the glass plates 11 are washed with the acid and alkali washing liquid, the glass plates 11 are dried by the vapor of IPA, which is an organic solvent having a low boiling point. IPA is hydrophilic and quickly vaporizes as it mixes with the acid washing liquid, the alkali washing liquid, and water. Thus, subsequent to the chemical strengthening step S15, the glass plates 11 are dried without forming traces of water on the surfaces of the glass plates 11.

(3) Every operation from the chemical strengthening step S15 to the warm water washing step S16 including the transfer of the glass plates 11 is performed in an atmosphere in which the amount of suspended material having a grain diameter of 0.5 μm or greater per cubic feet is 10,000 or less. This prevents material that is suspended in the air (e.g., dust) from collecting on the glass plates 11 during the operation and transfer of each step and improves the cleanness of the surfaces of the glass plates 11.

(4) The transfer and washing of the glass plates 11 from the first washing (scrubbing) step is performed in an atmosphere in which the amount of suspended material having a grain diameter of 0.5 μm or greater per cubic feet is 1,000 or less. Thus, the cleanness of the surfaces of the chemically strengthened glass plates 11 is maintained in a satisfactory manner. This effectively improves the yield of the manufactured glass plates 22.

(5) By using the transfer device 60 to transfer the glass plates 22 during the periods between the warm water washing step S16 and the first washing period S17, the difference between the cleanness until the warm water washing step S16 and the cleanness from the first washing step S17 is coped with. Thus, the cleanness from the first washing step S17 is maintained in a satisfactory manner, and deficient glass plates 22 are not produced.

(6) The glass plates 11, which are transferred in the transfer device 60, are placed in the container 34a in a state accommodated in the cage 34 and sealed in water. This prevents the material adhered to the glass plates 11 from being dispersed in the rooms in which each step is performed. Thus, the chemical strengthening liquid and molten salt adhered to the glass plates 11 do not collect on the first conveyer 61, the second conveyer 62, and the third conveyer 64. This prevents corrosion of the conveyers. Further, rust produced by the corrosion of glass plates, dust, and metal components that are collected on the glass plates 11 is prevented from being dispersed. Thus, the cleanness of the rooms performing each step does not decrease.

(7) In the chemical strengthening step S15, the glass plates 11 are chemically strengthened in a state in which the glass plates 11 are retained in the holders 33 and the holders 33 are accommodated in the cage 34. From after the chemical strengthening step S15 until the scrubbing step S17, the glass plates 11 are transferred in a state retained in the holders 33 and the cage 34, which are used in the chemical strengthening step S15. Thus, the glass plates 11 need not be removed. This simplifies operations. Further, the amount of the glass plates 11 that are processed in a single operation increases. This increases yield.

The preferred embodiment will now be discussed in more detail with reference to an example and a comparative example.

### EXAMPLE 1

The sheet-like glass plates 11 were cut in a disk-like manner to have a diameter of 65 mm and a thickness of 0.635 mm in the shaping step S12 and then chemically strengthened. Afterward, warm water washing, scrubbing, and surface washing were performed on the glass plates 11. The glass plates 11 were always immersed in water when transferred during steps S14, S17, and S18. Then, the glass plates 11 were dried to obtain the glass substrates of example 1.

### COMPARATIVE EXAMPLE 1

Until the chemical strengthening step S15, the same processes as example 1 were performed. From the warm water washing step S16 to the surface washing step S18, the glass plates 11 were transferred in a state in which the glass plates 11 were exposed to air and dried. When the glass plates 11 were dried, the glass substrates of comparative example 1 were obtained.

(Performance Evaluation)

The generating rate of pits in the glass substrates of example 1 and comparative example 1 were measured with a glass surface deficiency inspecting device (RS7000 manufactured by Hitachi Electronic Engineering Co., Ltd.). The pit generation rate of the glass substrates of example 1 was 0.0. In comparison, the pit generation rate of the glass substrates of comparative example 1 was 1.3. The results indicate that the pit generation rate decreases if the glass plates 11 are immersed in water when transferred to prevent the glass plates 11 from drying.

Further, 200 glass substrates were produced in example 1 and in comparative example 1. The yield of the 200 glass substrates was measured. Here, the glide-height yield (RG) was measured. In the glide-height measurement, a magnetic film was formed on the surface of each glass substrate, and a glide-height of 12 nm on the surfaces of the glass substrates was evaluated. The RG of the glass substrates of example 1 was 94%. In comparison, the RG of the glass substrates of comparative example 1 was 77%. This indicates that by immersing the glass plates 11 in water during transfer, the glass plates 11 are prevented from drying, deficient glass plates 11 are not produced, and yield is increased.

It should be apparent to those skilled in the art that the present invention may be embodied in many other specific forms without departing from the spirit or scope of the invention. Particularly, it should be understood that the present invention may be embodied in the following forms.

In each step, when transferring the glass plates 11 in a state immersed in water, ultrasonic waves may be emitted toward the glass plates 11 to eliminate material that is about to collect on the surfaces of the glass plates 11 and material suspended in the water. In this case, the cleanness of the glass plates 11 during transfer is effectively maintained.

During the period from the chemical strengthening step S15 to the warm water washing step S16, water may be sprayed against the surfaces of the glass plates 11 when transferring the glass plates 11. Alternatively, the glass plates 11 may be transferred in a highly humid atmosphere to prevent the surfaces of the glass plates 11 from drying. In this case, it is preferred that the humidity be maintained at about 100%.

The chemical washer 44 of the washing device 40 may form a texture on the surfaces of the glass plates 11. The texture is formed from pits having heights ranging from one nanometer to one micrometer and is formed by etching the surfaces of the glass plates 11 with, for example, an acid solution of hydrogen fluoride or an alkali solution of ammonium fluoride. In this case, a texture does not have to be formed in subsequent steps.

The present examples and embodiments are to be considered as illustrative and not restrictive, and the invention is not to be limited to the details given herein, but may be modified within the scope and equivalence of the appended claims.

What is claimed is:

1. A method for manufacturing an information recording medium glass substrate, the method comprising the steps of:
polishing and cleaning the surface of a glass plate;
chemically strengthening the glass plate by immersing the glass plate in a heated chemical strengthening liquid;
washing the glass plate with warm water after the chemical strengthening step to remove material adhered to the surface of the glass plate therefrom;
washing the glass plate after the warm water washing step to remove residual adhered material from the surface of the glass plate; and
transferring the glass plate from a location at which the warm water washing step is performed to a location at which the washing step is performed by wetting or moistening the glass plate with liquid.

2. The method according to claim 1, wherein the washing step includes:
a first washing step for scrubbing off the residual adhered material from the surface of the glass plate after the warm water washing step; and
a second washing step for removing the residual adhered material from the surface of the glass plate after the first washing step with an acid washing liquid and an alkali washing liquid.

3. The method according to claim 2, further comprising the step of:
transferring the glass plate from a location at which the first washing step is performed to a location at which the second washing step is performed by immersing the glass plate in liquid or by spraying liquid against the glass plate.

4. The method according to claim 3, further comprising the step of:
drying the surface of the glass plate after the second washing step by causing the vapor of an organic solvent that dissolves the liquid and has a low boiling point to contact the glass plate.

5. The method according to claim 4, wherein the organic solvent is isopropyl alcohol.

6. The method according to claim 2, wherein the second washing step includes forming a texture having fine pits on the surface of the glass plate with the acid washing liquid or with the alkali washing liquid.

7. The method according to claim 1, wherein the chemical strengthening step, the warm water washing step, and the transferring step are performed in a state in which a plurality of holders holding a plurality of the glass plates is accommodated in the cage.

8. The method according to claim 1, wherein the transferring step includes transferring the glass plate to a location at which the washing step is performed by way of a clean room.

9. The method according to claim 8, wherein the transfer step includes purifying the atmosphere of the clean room from a first cleanness level to a second cleanness level, which is more clean than the first cleanness level.

10. The method according to claim 9, wherein the first cleanness level is a state in which the amount of fine particles having a grain diameter of 0.5 μm or greater per cubic feet (0.028 cubic meter) is 10,000 or less, and the second cleanness level is a state in which the amount of fine particles having a grain diameter of 0.5 μm or greater per cubic feet is 1,000 or less.

11. The method according to claim 1, wherein the liquid is water having a temperature of 5° C. to 30° C.

12. A method for manufacturing an information recording medium glass substrate, the method comprising the steps of:
polishing and cleaning the surface of a glass plate;
chemically strengthening the glass plate by immersing the glass plate in a heated chemical strengthening liquid;
washing the glass plate with warm water after the chemical strengthening step to remove material adhered to the surface of the glass plate therefrom;
washing the glass plate after the warm water washing step to remove residual adhered material from the surface of the glass plate, wherein the washing step includes a first washing step for scrubbing off the residual adhered material from the surface of the glass plate after the warm water washing step, and a second washing step for removing the residual adhered material from the surface of the glass plate after the first washing step with an acid washing liquid and an alkali washing liquid;
transferring the glass plate from a location at which the warm water washing step is performed to a location at which the washing step is performed by wetting or moistening the glass plate with liquid; and
transferring the glass plate from a location at which the first washing step is performed to a location at which the second washing step is performed by wetting or moistening the glass plate with liquid.

13. An apparatus for manufacturing an information recording medium glass substrate, the apparatus comprising:
a chemical strengthening furnace for immersing a glass plate in a heated chemical strengthening liquid to perform chemical strengthening;
a warm water washing device for washing the glass plate with warm water after the chemical strengthening to remove material adhered to the surface of the glass plate therefrom;
a washing device for washing the glass plate after washing the glass plate with warm water to remove residual adhered material from the surface of the glass plate; and
a transfer device for transferring the glass plate from the warm water washing device to the washing device by wetting or moistening the glass plate with liquid.

14. The apparatus according to claim 13, wherein the transfer device includes:
an air purifier arranged between the warm water device and the washing device to receive the glass plate and send the glass plate to the washing device, wherein the air purifier includes a clean room, the interior of which is purified to shift from a first atmosphere in which the amount of fine particles having a grain diameter of 0.5 μm or greater per cubic feet (0.028 cubic meter) is 10,000 or less to a second atmosphere in which the amount of fine particles having a grain diameter of 0.5 μm or greater per cubic feet is 1,000 or less.

15. The apparatus according to claim 13, wherein the washing device includes:
a scrubber for scrubbing off the residual adhered material from the surface of the glass plate;
a chemical washer for removing the residual adhered material from the surface of the glass plate after the scrubbing with an acid washing liquid and an alkali washing liquid; and
a conveyer arranged between the scrubber and the chemical washer to transfer the glass plate from the scrubber to the chemical washer in a state in which the glass plate is wet or moistened with liquid.

16. The apparatus according to claim 15, wherein the conveyer includes:
a transfer tank for containing liquid, wherein the transfer tank is an elongated box and has an opened top;
a conveying belt arranged on the inner bottom surface of the transfer tank to transfer the glass plate in a state in which the glass plate is immersed in the liquid of the transfer tank.

17. The apparatus according to claim 15, wherein the chemical washer includes an acid washer for performing acid washing and an alkali washer for performing alkali washing, wherein the chemical washer washes the surface of the glass plate and forms a texture having fine pits on the surface of the glass plate.

18. The apparatus according to claim 13, wherein the warm water washer includes:
a warm water washing tank for containing warm water in which the glass plate is immersed; and
an air supply pipe arranged on the inner bottom surface of the warm water washing tank to release air and produce bubbles in the warm water washing tank so that the bubbles contact the glass plate and free adhered material from the surface of the glass plate.

19. A washing device used to manufacture an information recording medium glass substrate, the washing device comprising:
a scrubber for scrubbing off adhered material from the surface of the glass plate after the glass plate is polished;
a chemical washer for removing residual adhered material from the surface of the glass plate after the scrubbing with an acid washing liquid and an alkali washing liquid; and
a conveyer arranged between the scrubber and the chemical washer to transfer the glass plate from the scrubber to the chemical washer, wherein the conveyer includes a transfer tank for containing liquid, and a conveying belt arranged on the inner bottom surface of the transfer tank to transfer the glass plate in a state in which the glass plate is immersed in the liquid of the transfer tank.

20. A transfer device used to manufacture an information recording medium glass substrate, wherein the transfer device transfers a glass plate between a warm water washing device and a washing device, the transfer device comprising:
a first conveyer for transferring the glass plate after the glass plate is washed with warm water;
an air purifier having a clean room for accommodating the glass plate transferred by the first conveyer, wherein the air purifier purifies the clean room accommodating the glass plate so that the clean room shifts from a first atmosphere in which the amount of fine particles having a grain diameter of 0.5 μm or greater per cubic feet (0.028 cubic meter) is 10,000 or less to a second atmosphere in which the amount of fine particles having a grain diameter of 0.5 μm or greater per cubic feet (0.028 cubic meter) is 1,000 or less; and
a second conveyer for transferring the glass plate from the air purifier to the washing device, wherein the air purifier includes a third conveyer for moving the glass plate from the first conveyer to the second conveyer in a state is which the glass plate is wet or moistened with liquid.
